(19) United States
(12) Patent Application Publication
(10) Pub. No.: US 2026/0038183 A1
(43) Pub. Date: Feb. 5, 2026

(54) FAST MSAA TECHNIQUES FOR GRAPHICS PROCESSING

(71) Applicant: QUALCOMM Incorporated, San Diego, CA (US)

(72) Inventors: Caiqin LI, Shanghai (CN); Yanshan WEN, Shanghai (CN); Qi JIN, Shanghai (CN); Adimulam RAMESH BABU, San Diego, CA (US); Srihari Babu ALLA, San Diego, CA (US)

(21) Appl. No.: 19/103,500

(22) PCT Filed: Sep. 15, 2022
(86) PCT No.: PCT/CN2022/118898

§ 371 Date: Feb. 12, 2025

(51) Int. Cl. G06T 15/00; G06T 7/50; G06T 7/90; G06T 15/04

(52) U.S. Cl. CPC G06T 15/005; G06T 7/50; G06T 7/90; G06T 15/04; G06T 2200/12; G06T 2207/10024

(57) ABSTRACT

Aspects presented herein relate to methods and devices for graphics processing including an apparatus, e.g., a GPU or a CPU. The apparatus may obtain a set of primitives including pixels associated with at least one current frame. The apparatus may also configure a coverage mask associated with each pixel, where each pixel corresponds to a sample. Further, the apparatus may calculate color data or depth data associated with each pixel, where the color data includes a current color value and the depth data includes a current depth value. The apparatus may also update the current color value or the current depth value for each pixel based on the at least one coverage mask. The apparatus may also blend the updated current color value with a previous color value for each of pixel.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modem day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform graphics processing. The apparatus may obtain a set of primitives associated with at least one current frame in a scene, where each of the set of primitives is associated with at least one pixel of a plurality of pixels in the at least one current frame. The apparatus may also configure at least one coverage mask associated with each pixel of the plurality of pixels, where each of the plurality of pixels corresponds to at least one sample, where the at least one coverage mask is based on the at least one sample for each of the plurality of pixels. Further, the apparatus may calculate at least one of color data or depth data associated with each of the plurality of pixels, where the color data includes a current color value for each of the plurality of pixels, where the depth data includes a current depth value for each of the plurality of pixels. The apparatus may also transmit an indication of at least one of the color data or the depth data associated with each of the plurality of pixels, where the indication is transmitted after calculating at least one of the color data or the depth data associated with each of the plurality of pixels. Moreover, the apparatus may update at least one of the current color value or the current depth value for each of the plurality of pixels based on the at least one coverage mask. The apparatus may also perform a depth test for each of the plurality of pixels prior to the updated current color value being blended with the previous color value for each of the plurality of pixels. Also, the apparatus may blend the updated current color value for each of the plurality of pixels with a previous color value for each of the plurality of pixels based on the at least one coverage mask, where the updated current color value is associated with at least one current draw for the scene, and where the previous color value is associated with at least one previous draw for the scene. The apparatus may also store at least one of the updated current color value or the updated current depth value for each of the plurality of pixels after the updated current color value is blended with the previous color value for each of the plurality of pixels.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example image or surface in accordance with one or more techniques of this disclosure.

FIG. 4 is a graph illustrating example frames for graphics processing.

FIG. 5 is a diagram illustrating an example multi-sample anti-aliasing (MSAA) workflow for graphics processing.

FIG. 6 is a diagram illustrating an example MSAA workflow for graphics processing.

FIG. 7 is a diagram illustrating example draws for graphics processing.

FIG. 8 is a communication flow diagram illustrating example communications between GPU components.

FIG. 9 is a flowchart of an example method of graphics processing.

FIG. 10 is a flowchart of an example method of graphics processing.

### DETAILED DESCRIPTION

Some types of GPUs may render polygons by sampling objects at discrete pixel locations, which may cause an aliasing effect on the edges of the object. For example, when rendering an object on a screen, there may be jagged saw-like patterns along the edges of models, which is called aliasing. There are quite a few techniques called anti-aliasing techniques that fight this aliasing behavior by producing smoother edges. That is, anti-aliasing is a method for handling pixel display issues, such as rough or jagged edges, by smoothing the displayed edges of pixels. Multi-sample anti-aliasing (MSAA) is one of a number of anti-aliasing techniques used for smoothening pixel edges. This anti-aliasing technique may rely on sampling the same pixel at multiple locations (e.g., 2, 4, 8, or 16 samples per pixel) and then determining what percentage of the pixel is inside or outside of an object. This information may be used later to blend pixel colors in order to smooth the rough pixel edges. In order to use the aforementioned anti-aliasing techniques, each pixel may need up to four times more storage (e.g., in the case of 4xMSAA) and more computational overhead (e.g., approximately 10% more overhead). This can lead to a drop (e.g., a 25%-30% drop) in overall benchmark performance. Also, this technique may limit the user to apply deferred lighting algorithms, which can be used in rendering scenes with multiple light sources, as the sample level information may be lost when resolving the final frame buffer. Additionally, some game developers may provide distance-to-edge based algorithms as an alternative to MSAA, but they may be either software implementations based on post-processing pixels to detect edges or cannot handle sub-pixel primitives. In some instances, tile-based GPUs may be capable of performing multi-sampled rendering by storing multi-sample data in internal high-speed memory and downsampling the data when writing out to external memory after the rendering has finished. This approach may save bandwidth and/or storage space, as per-sample data may not be written out to external memory. Further, this type of approach may be widely used in certain types of rendering, such as mobile game rendering. In some aspects, as multi-sample data may be stored in a GPU memory (GMEM), the GMEM may be used to render a smaller portion of an entire frame. The bin count for frames associated with MSAA may be larger than the bin count without MSAA, which may result in an increased binning overhead. For example, for a same render target (e.g., an 2192×954 red (R) green (G) blue (B) alpha (A) (RGBA) 8888 render target), non-MSAA may utilize 12 bins, while 4xMSAA may utilize 48 bins. Downsampling may be needed when writing GMEM data out to external memory after rendering has finished. If there are format restrictions, another block may be used for downsampling, which may take more time than a three-dimensional (3D) resolve engine. For some formats, 4xMSAA may result in an increase in overhead (e.g., a 28% or 70% increase in overhead) compared to 1xMSAA. Indeed, utilizing certain types of MSAA may result in wasting GPU internal resources (i.e., corresponding to all the data in a GPU that is multi-sampled), but also result in merely a small edge quality improvement. Aspects of the present disclosure may utilize MSAA with improved edge quality. For instance, aspects of the present disclosure may utilize MSAA with increased performance benefits. Additionally, in some instances, aspects of the present disclosure may utilize MSAA with an increased processing speed. By doing so, aspects presented herein may optimize the performance benefits for MSAA solutions. Further, aspects presented herein may reduce the amount of memory bandwidth and overhead associated with utilizing MSAA.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

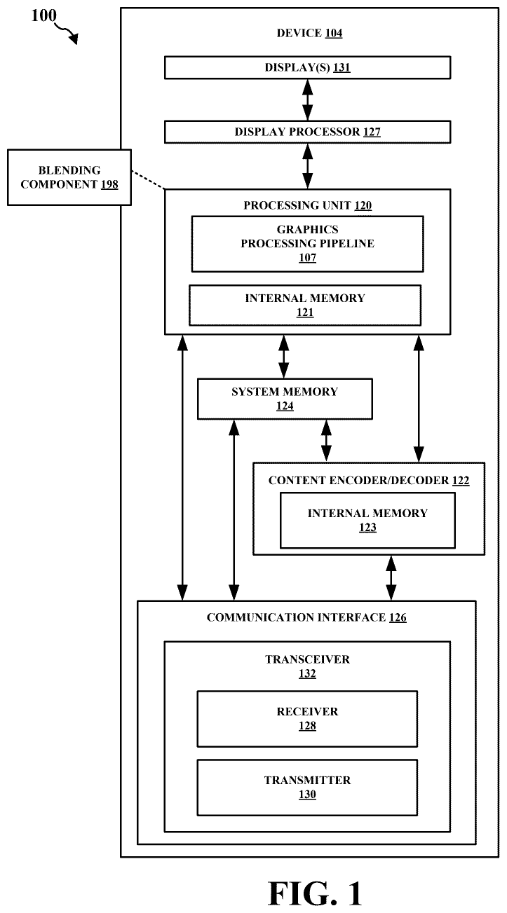

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a blending component 198 configured to obtain a set of primitives associated with at least one current frame in a scene, where each of the set of primitives is associated with at least one pixel of a plurality of pixels in the at least one current frame. The blending component 198 may also be configured to configure at least one coverage mask associated with each pixel of the plurality of pixels, where each of the plurality of pixels corresponds to at least one sample, where the at least one coverage mask is based on the at least one sample for each of the plurality of pixels. The blending component 198 may also be configured to calculate at least one of color data or depth data associated with each of the plurality of pixels, where the color data includes a current color value for each of the plurality of pixels, where the depth data includes a current depth value for each of the plurality of pixels. The blending component 198 may also be configured to transmit an indication of at least one of the color data or the depth data associated with each of the plurality of pixels, where the indication is transmitted after calculating at least one of the color data or the depth data associated with each of the plurality of pixels. The blending component 198 may also be configured to update at least one of the current color value or the current depth value for each of the plurality of pixels based on the at least one coverage mask. The blending component 198 may also be configured to perform a depth test for each of the plurality of pixels prior to the updated current color value being blended with the previous color value for each of the plurality of pixels. The blending component 198 may also be configured to blend the updated current color value for each of the plurality of pixels with a previous color value for each of the plurality of pixels based on the at least one coverage mask, where the updated current color value is associated with at least one current draw for the scene, and where the previous color value is associated with at least one previous draw for the scene. The blending component 198 may also be configured to store at least one of the updated current color value or the updated current depth value for each of the plurality of pixels after the updated current color value is blended with the previous color value for each of the plurality of pixels. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

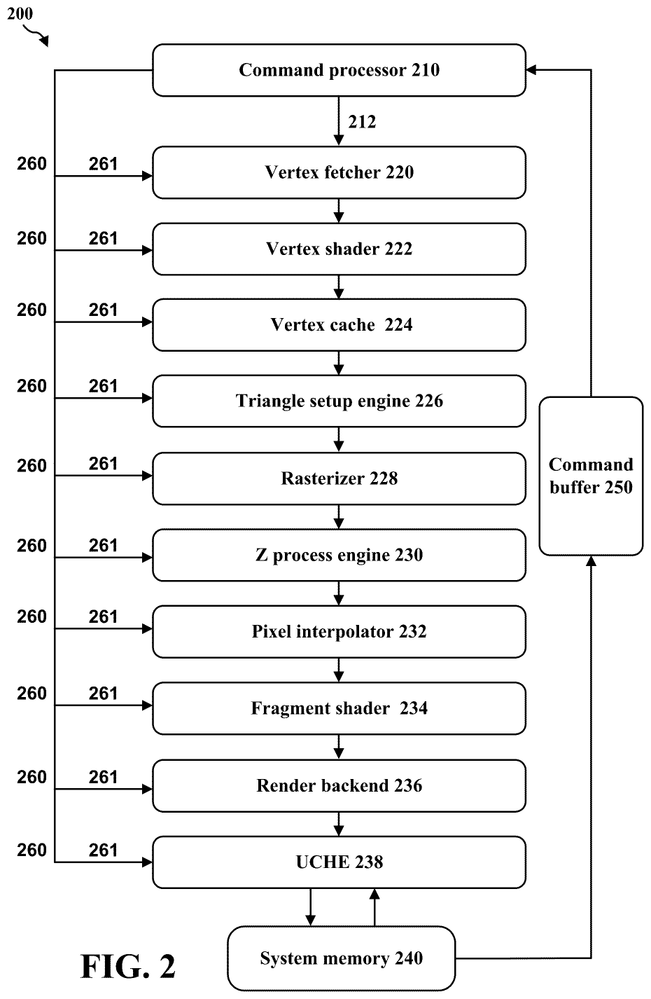

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

In some aspects, GPUs may apply the drawing or rendering process to different bins or tiles. For instance, a GPU may render to one bin, and perform all of the draws for the primitives or pixels in the bin. During the process of rendering to a bin, the render targets may be located in the GMEM. In some instances, after rendering to one bin, the content of the render targets may be moved to a system memory and the GMEM may be freed for rendering the next bin. Additionally, a GPU may render to another bin, and perform the draws for the primitives or pixels in that bin. Therefore, in some aspects, there might be a small number of bins, e.g., four bins, that cover all of the draws in one surface. Further, GPUs may cycle through all of the draws in one bin, but perform the draws for the draw calls that are visible, i.e., draw calls that include visible geometry. In some aspects, a visibility stream may be generated, e.g., in a binning pass, to determine the visibility information of each primitive in an image or scene. For instance, this visibility stream may identify whether a certain primitive is visible or not. In some aspects, this information may be used to remove primitives that are not visible, e.g., in the rendering pass. Also, at least some of the primitives that are identified as visible may be rendered in the rendering pass.

In some aspects of tiled rendering, there may be multiple processing phases or passes. For instance, the rendering may be performed in two passes, e.g., a visibility or bin-visibility pass and a rendering or bin-rendering pass. During a visibility pass, a GPU may input a rendering workload, record the positions of the primitives or triangles, and then determine which primitives or triangles fall into which bin or area. In some aspects of a visibility pass, GPUs may also identify or mark the visibility of each primitive or triangle in a visibility stream. During a rendering pass, a GPU may input the visibility stream and process one bin or area at a time. In some aspects, the visibility stream may be analyzed to determine which primitives, or vertices of primitives, are visible or not visible. As such, the primitives, or vertices of primitives, that are visible may be processed. By doing so, GPUs may reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information may be used to determine or generate a visibility stream. In a rendering pass, the primitives in each bin may be rendered separately. In these instances, the visibility stream may be fetched from memory used to drop primitives which are not visible for that bin.

Some aspects of GPUs or GPU architectures may provide a number of different options for rendering, e.g., software rendering and hardware rendering. In software rendering, a driver or CPU may replicate an entire frame geometry by processing each view one time. Additionally, some different states may be changed depending on the view. As such, in software rendering, the software may replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware may manage the replication or processing of the primitives or triangles for each viewpoint in an image.

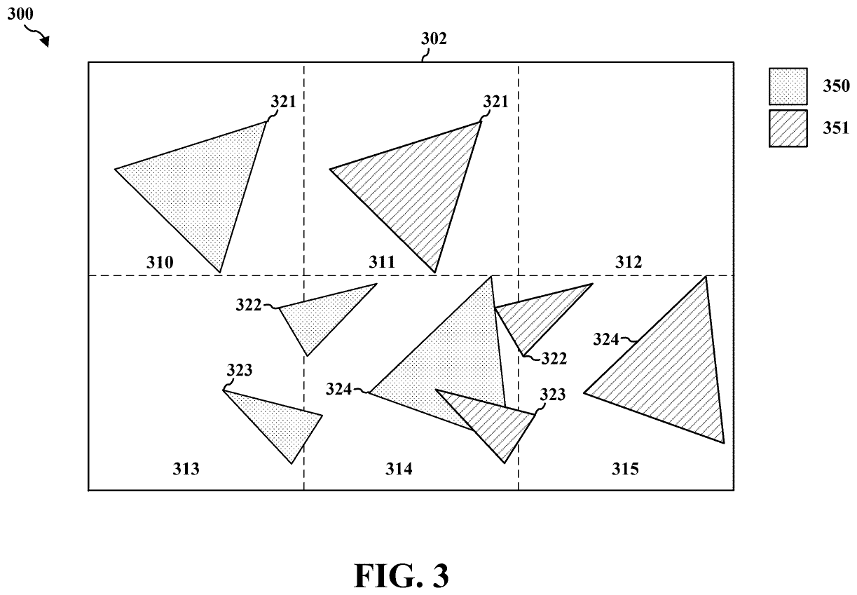

FIG. 3 illustrates image or surface 300, including multiple primitives divided into multiple bins. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 may utilize multiple viewpoints or multi-view rendering.

As indicated herein, GPUs or graphics processor units may use a tiled rendering architecture to reduce power consumption or save memory bandwidth. As further stated above, this rendering method may divide the scene into multiple bins, as well as include a visibility pass that identifies the triangles that are visible in each bin. Thus, in tiled rendering, a full screen may be divided into multiple bins or tiles. The scene may then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM), e.g., containing a bitmap or storage, to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

Some types of GPUs may render polygons by sampling objects at discrete pixel locations, which may cause an aliasing effect on the edges of the object. For example, when rendering an object on a screen, there may be jagged saw-like patterns along the edges of models, which is called aliasing. There are quite a few techniques called anti-aliasing techniques that fight this aliasing behavior by producing smoother edges. That is, anti-aliasing is a method for handling pixel display issues, such as rough or jagged edges, by smoothing the displayed edges of pixels. Multi-sample anti-aliasing (MSAA) is one of a number of anti-aliasing techniques used for smoothening pixel edges. This anti-aliasing technique may rely on sampling the same pixel at multiple locations (e.g., 2, 4, 8, or 16 samples per pixel) and then determining what percentage of the pixel is inside or outside of an object. This information may be used later to blend pixel colors in order to smooth the rough pixel edges.

In order to use the aforementioned anti-aliasing techniques, each pixel may need up to four times more storage (e.g., in the case of 4xMSAA) and more computational overhead (e.g., approximately 10% more overhead). This can lead to a drop (e.g., a 25%-30% drop) in overall benchmark performance. Also, this technique may limit the user to apply deferred lighting algorithms, which can be used in rendering scenes with multiple light sources, as the sample level information may be lost when resolving the final frame buffer. Additionally, some game developers may provide distance-to-edge based algorithms as an alternative to MSAA, but they may be either software implementations based on post-processing pixels to detect edges or cannot handle sub-pixel primitives. In some instances, tile-based GPUs may be capable of performing multi-sampled rendering by storing multi-sample data in internal high-speed memory and downsampling the data when writing out to external memory after the rendering has finished. This approach may save bandwidth and/or storage space, as per-sample data may not be written out to external memory. Further, this type of approach may be widely used in certain types of rendering, such as mobile game rendering.

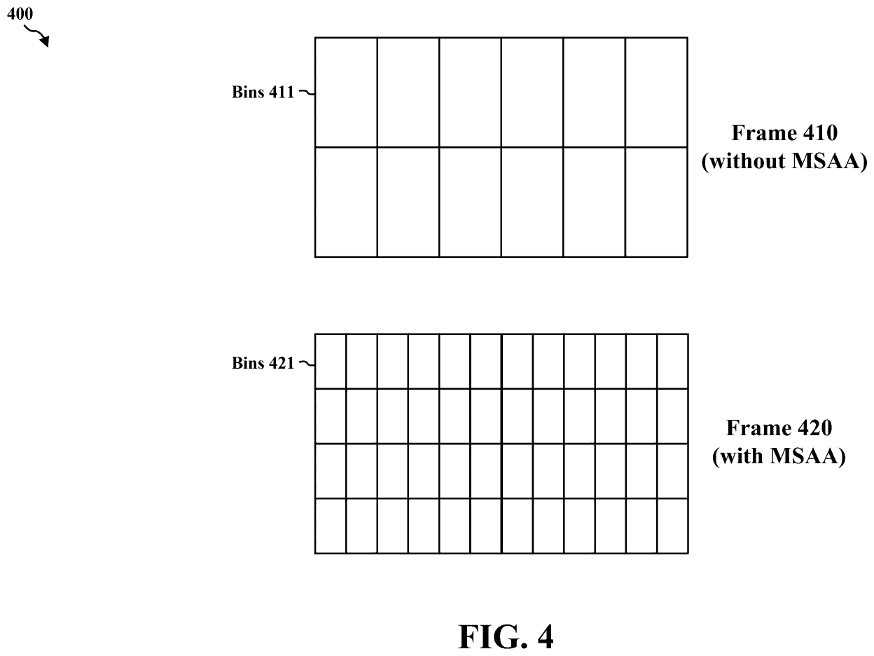

FIG. 4 is a diagram 400 illustrating example frames for graphics processing. More specifically, diagram 400 depicts frame 410 without utilizing MSAA and frame 420 utilizing MSAA. As shown in FIG. 4, diagram 400 includes frame 410 including bins 411 and frame 420 including bins 421. Diagram 400 illustrates that there are 12 bins included in bins 411 in frame 410 and 48 bins included in bins 421 in frame 420. That is, frame 420 utilizes a certain type of MSAA (e.g., 4xMSAA), so frame 420 utilizes four times the amount of bins as frame 410.

In some aspects, as multi-sample data may be stored in a GPU memory (GMEM), the GMEM may be used to render a smaller portion of an entire frame. As depicted in FIG. 4, the bin count for frames associated with MSAA may be larger than the bin count without MSAA, which may result in an increased binning overhead. For example, as shown in FIG. 4, for a same render target (e.g., an 2192×954 RGBA8888 render target), non-MSAA may utilize 12 bins, while 4xMSAA may utilize 48 bins. Downsampling may be needed when writing GMEM data out to external memory after rendering has finished. If there are format restrictions, another block may be used for downsampling, which may take more time than a three-dimensional (3D) resolve engine. For some formats, 4xMSAA may result in an increase in overhead (e.g., a 28% or 70% increase in overhead) compared to 1xMSAA. Indeed, utilizing certain types of MSAA may result in wasting GPU internal resources (i.e., corresponding to all the data in a GPU that is multi-sampled), but also result in merely a small edge quality improvement. Based on the above, it may be beneficial to utilize MSAA with improved edge quality. That is, it may beneficial to utilize MSAA with an increased performance benefit, as well as an increased processing speed. Moreover, it may be beneficial to reduce the amount of memory bandwidth and overhead associated with utilizing MSAA.

Aspects of the present disclosure may utilize MSAA with improved edge quality. For instance, aspects of the present disclosure may utilize MSAA with increased performance benefits. Additionally, in some instances, aspects of the present disclosure may utilize MSAA with an increased processing speed. By doing so, aspects presented herein may optimize the performance benefits for MSAA solutions. Further, aspects presented herein may reduce the amount of memory bandwidth and overhead associated with utilizing MSAA.

GPUs may utilize a number of workflows for MSAA. For instance, GPUs may obtain a set of primitives or triangles. The rasterizer may generate a sample coverage mask for each pixel based on the MSAA level. A GMEM or GPU memory may then store per-sample data, including color values and depth values. A shader processor may calculate the color value once for each pixel. The render backend (RB) may update this color value to each sample based on a sample coverage mask. For the edge of the primitive or triangle, GPUs may update the color value to each sample when the sample is covered. If the sample is inside of the primitive or triangle, the GPU may update the color value. If the sample is outside of the primitive or triangle, the color value of the sample may remain the previous color value. If a depth test is enabled, the RB may perform a per-sample basis depth test, which may compare the current depth value and the previous depth value stored in the GMEM. If the sample passes the depth test or depth test is disabled, the RB may perform a per-sample blending (i.e., if blending is enabled) and the resulting color may be written back into the GMEM. The GMEM data may also be per-sample, while the system memory may be per-pixel, so the GPU may need to down-sample (i.e., average the color value for N samples and select a sample as the depth value).

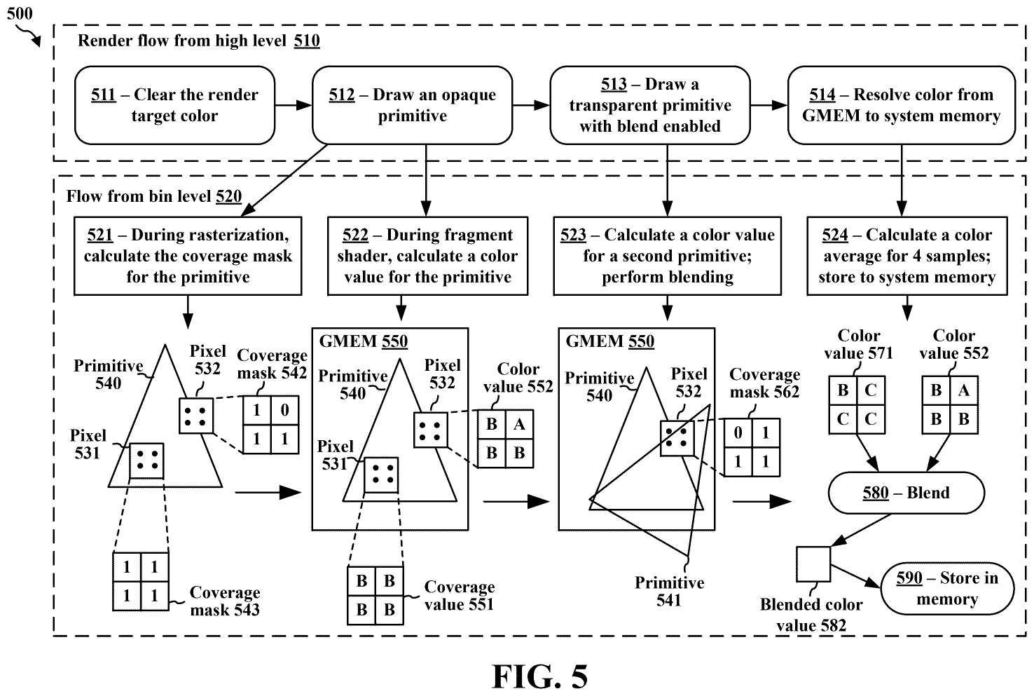

FIG. 5 is a diagram 500 illustrating an example MSAA workflow for graphics processing. More specifically, diagram 500 depicts an MSAA workflow including a render flow from high level 510 and a flow from bin level 520. As shown in FIG. 5, in render flow from high level 510, at step 511, the render target color may be cleared (e.g., cleared to black). At step 512, the GPU may draw an opaque primitive or triangle. At step 513, the GPU may draw a transparent primitive with blending enabled. For example, this may be based on the following formula: Colorᵣₑₛᵤₗₜ=Color_{src}*Alpha_{src}+Color_{dst}*(1−Alpha_{src}). At step 514, the GPU may resolve the color from a GPU memory (e.g., 4 samples) to a system memory (e.g., 1 sample). As further shown in FIG. 5, in flow from bin level 520, at step 521, the GPU may calculate the coverage mask for a primitive during rasterization. This is shown in FIG. 5 with primitive 540 including pixel 531 and pixel 532, where coverage mask 542 and coverage mask 543 are calculated. At step 522, the GPU may calculate a color value for the primitive in a fragment shader. This is shown in FIG. 5 where color value 552 and color value 551 are calculated for primitive 540 in GMEM 550. At step 523, the GPU may calculate a color value for a second primitive (e.g., primitive 541), and then perform a blending process. For example, color value 571 may be calculated for primitive 541 based on coverage mask 562, which may be blended at 580 with color value 552. At step 524, the GPU may calculate a color average for four samples, and then store this to the system memory. The blended color value 582 may be used to calculate a color average, which at 590 may be stored in system memory.

GPUs according to the present disclosure may utilize a number of different workflows for MSAA. For instance, according to the aspects of the present disclosure, GPUs may obtain a set of primitives or triangles. The rasterizer may generate a sample coverage mask for each pixel based on the MSAA level. A GMEM or GPU memory may then store per-pixel data, including color values and depth values. A shader processor may calculate the color value for each pixel (e.g., once for each pixel). The render backend (RB) may calculate the current color value and a previous color value based on a per-sample coverage mask. If a depth test is enabled, the RB may perform a per-pixel basis depth test, which compares the current depth value and the previous depth value stored in the GMEM. If the pixel passes the depth test or depth test is disabled, the RB may perform a per-pixel blending (i.e., if blending is enabled) and the resulting color may be written back into the GMEM. The per-pixel data may be stored from the GMEM to the system memory.

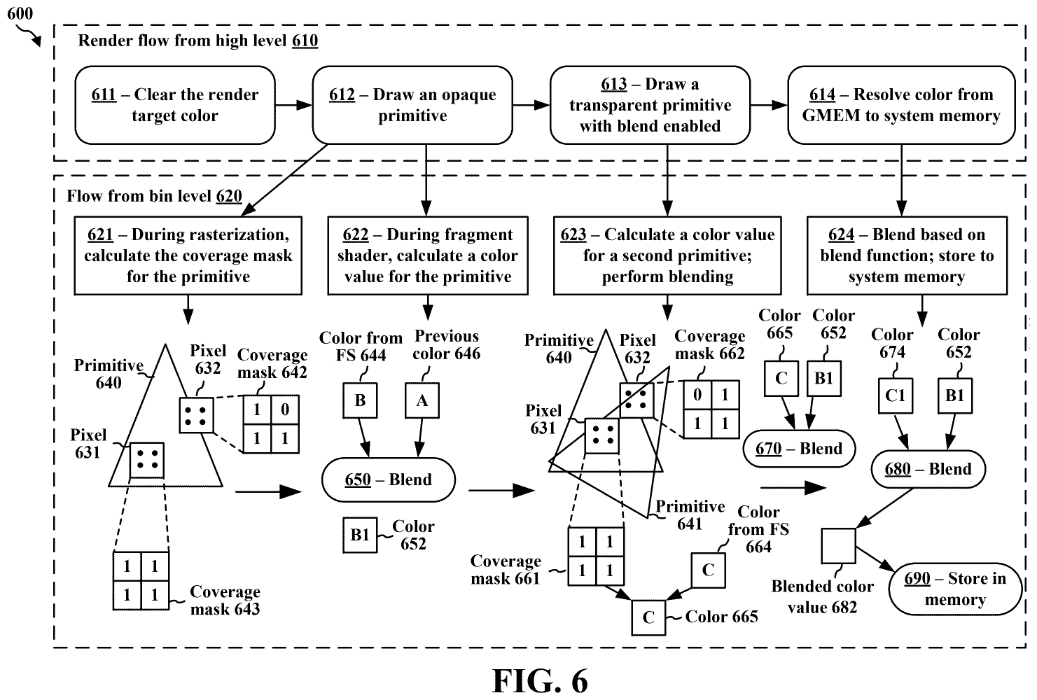

FIG. 6 is a diagram 600 illustrating an example fast MSAA workflow for graphics processing. More specifically, diagram 600 depicts a fast MSAA workflow including a render flow from high level 610 and a flow from bin level 620. As shown in FIG. 6, in render flow from high level 610, at step 611, the render target color may be cleared (e.g., cleared to black). At step 612, the GPU may draw an opaque primitive or triangle. At step 613, the GPU may draw a transparent primitive with blending enabled. For example, this may be based on the following formula: Colorᵣₑₛᵤₗₜ −Color_{src}*Alpha_{src}+Color_{dst}*(1−Alpha_{src}). At step 614, the GPU may resolve the color from a GPU memory (e.g., 1 samples) to a system memory (e.g., 1 sample).

As further shown in FIG. 6, in the flow from bin level 620, at step 621, the GPU may calculate the coverage mask for a primitive during rasterization. This is shown in FIG. 6 with primitive 640 including pixel 631 and pixel 632, where coverage mask 642 and coverage mask 643 are calculated. At step 622, the GPU may calculate a color value for the primitive in a fragment shader (FS). This is shown in FIG. 6 where color from FS 644 and previous color value 646 are calculated for primitive 640, and are then blended at 650. For example, the blended value may be ¾ of FS 644 and ¼ of previous color value 646. In some instances, if there is a full coverage mask, there may be no need to perform the blend. At step 623, the GPU may calculate a color value for a second primitive, and then perform a blending process. For example, coverage mask 661 and coverage mask 662 may be calculated for primitive 641. The coverage mask 661 and color from FS 664 may be combined to obtain color value 665. Color value 665 may then be blended with color value 652 at step 670, which may produce color value 674 (e.g., ¾ of color value 665 and ¼ of color value 652). At step 624, the GPU may blend based on a blend function, and then store this to the system memory. For instance, color value 674 and color value 652 may be blended at step 680, which may produce blended color value 682. The blended color value 682 may be based on a certain formula (e.g., color value 674*Alpha+(1−Alpha)*color value 652), which may be stored in system memory (e.g., a buffer in system memory) at step 690.

In some aspects, overdraws at the GPU may affect a final pixel value. That is, aspects presented herein may achieve an anti-aliasing effect for the edges, but if the same pixel has several partially covered overdraws, a final color may contain the color value of previous draws. This may be based on the following formula:

$${c}_{1} = \frac{1}{4} * {p}_{1}^{T} I * {d}_{1} + \frac{1}{4} * {( I - {p}_{1} )}^{T} I * {c}_{0} .$$

### Here,

$${p}_{n} = ( \begin{matrix}{p}_{n , 0} \\ {p}_{n , 1} \\ {p}_{n , 2} \\ {p}_{n , 3}\end{matrix} ) ,$$

where p_{n,j} ∈{0, 1}, j∈{0, 1, 2, 3}, and

$$I = ( \begin{matrix}1 \\ 1 \\ 1 \\ 1\end{matrix} ) .$$

Also, pₙ may represent the pixel's coverage mask of a certain draw (e.g., the nth draw). Further, dₙ may be the pixel value rendered by the nth draw, cₙ may be the pixel value after a certain amount of overdraw (e.g., n times overdraw), and co may be the original pixel value. If

$${p}_{n} = ( \begin{matrix}1 \\ 1 \\ 1 \\ 1\end{matrix} ) ,$$

this may mean that the nth draw covers the whole pixel. Moreover, if

$${p}_{n} = ( \begin{matrix}0 \\ 0 \\ 0 \\ 0\end{matrix} ) ,$$

it may mean the nth draw does not touch this pixel.

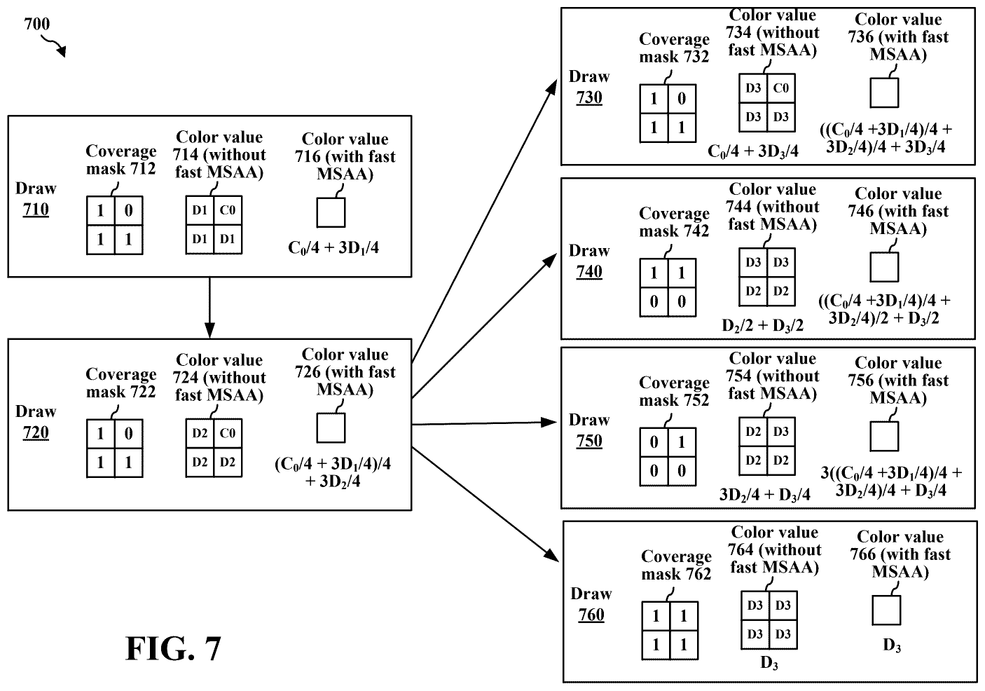

FIG. 7 is a diagram 700 illustrating example draws for graphics processing. More specifically, diagram 700 depicts a number of draws and corresponding coverage masks, as well as a final color value utilizing fast MSAA and without fast MSAA (i.e., comparing the final color value utilizing aspects presented herein and without utilizing aspects presented herein). As shown in FIG. 7, diagram 700 includes a number of overdraws (e.g., three overdraws), where draw 710 and draw 720 may have the same coverage mask for the pixel. For a third draw, four cases are listed to compare the difference (e.g., draw 730, draw 740, draw 750, and draw 760). Draw 710 includes coverage mask 712, as well as color value 714 (without fast MSAA) and color value 716 (with fast MSAA techniques of the present disclosure). Coverage mask 712 includes values (1, 0, 1, 1), color value 714 corresponds to (D1, C0, D1, D1), and color value 716 corresponds to: C₀/4+3D₁/4. Draw 720 includes coverage mask 722, as well as color value 724 (without fast MSAA) and color value 726 (with fast MSAA). Coverage mask 722 includes values (1, 0, 1, 1), color value 714 corresponds to (D2, C0, D2, D2), and color value 726 corresponds to: (C₀/4+3D₁/4)/4+3D₂/4. Draw 730 includes coverage mask 732, as well as color value 734 (without MSAA) and color value 736 (with MSAA). Coverage mask 732 includes values (1, 0, 1, 1), color value 734 corresponds to (D3, C0, D3, D3) and C₀/4+3D₃/4, and color value 736 corresponds to: ((C₀/4+3D₁/4)/4+3D₂/4)/4+3D₃/4. Draw 740 includes coverage mask 742, as well as color value 744 (without fast MSAA) and color value 746 (with fast MSAA). Coverage mask 742 includes values (1, 1, 0, 0), color value 744 corresponds to (D3, D3, D2, D2) and D2/2+D₃/2, and color value 746 corresponds to: ((C₀/4+3D₁/4)/4+3D₂/4)/2+D₃/2. Draw 750 includes coverage mask 752, as well as color value 754 (without fast MSAA) and color value 756 (with fast MSAA). Coverage mask 752 includes values (0, 1, 0, 0), color value 754 corresponds to (D2, D3, D2, D2) and 3D₂/4+D₃/4, and color value 756 corresponds to: 3((C₀/4+3D₁/4)/4+3D₂/4)/4+D₃/4. Draw 760 includes coverage mask 762, as well as color value 764 (without fast MSAA) and color value 766 (with fast MSAA). Coverage mask 762 includes values (1, 1, 1, 1), color value 764 corresponds to (D3, D3, D3, D3) and D₃, and color value 766 corresponds to: D₃.

As indicated herein, overdraws may affect the final color value for aspects of the present disclosure. For instance, one simulation result of 3 draws on the same primitive or triangle may result in a low quality case. However, in a real mobile application or game, the overdraw of the same primitive may not be likely to occur. This may result because applications or games may not draw the same mesh with a different color several times. Additionally, in some instances, there may be close to no discernable difference both with and without fast MSAA. For example, the intersection point may have a small color difference. By doing so, this may improve the rendering output of aspects presented herein, and result in acceptable rendering outputs in most cases.

Aspects presented herein may allow GPUs to reduce the amount of GMEM space utilized, as data may be stored on a per-pixel basis. In some cases (e.g., 4xMSAA), this approach may save a certain amount of memory (e.g., 6/8 memory). Further, aspects presented herein may allow GPUs to achieve an anti-aliasing effect for the edges, and may produce faster results compared to traditional MSAA solutions. In some cases (e.g., where a depth test is not enabled), rendering both with and without utilizing fast MSAA may be similar, except for some intersection points. This intersection point difference may be reset if the next draw covers a certain pixel. In other cases (e.g., where a depth test is enabled), a per-pixel depth test may be performed, which may result in an increased rendering difference compared to traditional MSAA solutions. The image quality when utilizing aspects presented herein may be between non-MSAA solutions and traditional MSAA solutions (e.g., 4xMSAA).

Additionally, GPUs according to the present disclosure may utilize a number of different workflows for MSAA. For instance, according to the present disclosure GPUs may obtain a set of primitives or triangles. The rasterizer may generate a sample coverage mask for each pixel based on the MSAA level. A GMEM or GPU memory may then store per-pixel data for color values and per-sample data for depth values. A shader processor may then calculate the color value for each pixel. The render backend (RB) may create a merged sample mask (mergeMask), where the merged sample mask may be equal to a per-sample coverage mask and a per-sample depth test mask. The RB may blend the current color and the previous color based on the merged sample mask. If blending is disabled, the RB may write back the resulting color to the GMEM. If a depth test is enabled, a per-sample depth test may be performed. If blending is enabled, the RB may perform per-pixel blending and may write back the resulting color to the GMEM. The pixel level color data may then be stored from the GMEM to the system memory. In some instances, the depth may be discarded, such that down sampling depth may not be utilized. This type of aforementioned procedure may utilize an increased amount of GMEM space, but may result in an improved image quality.

Aspects of the present disclosure may include a number of benefits or advantages. Aspects presented herein may utilize fast MSAA with improved edge quality. For instance, aspects of the present disclosure may utilize fast MSAA with an increased performance benefit. Additionally, in some instances, aspects of the present disclosure may utilize fast MSAA with an increased processing speed. By doing so, aspects presented herein may optimize the performance benefits for MSAA solutions. Further, aspects presented herein may reduce the amount of memory bandwidth and overhead associated with utilizing fast MSAA. In some instances, the aforementioned procedures may utilize GPU hardware changes, so it may be difficult to provide real case performance data. However, utilizing the aforementioned procedures may result in expected performance benefits. For example, the amount of GPU memory utilized may be reduced since the color data is stored per-pixel. Also, a final down-sample stage may be saved. From an image quality perspective, for pixels on the inside (or on the edge) of the primitive or triangle, the final color value may be precise. Aspects presented herein may also help to achieve an anti-aliasing effect. Further, aspects presented herein may provide fast solutions for MSAA that may be used in a number of different cases (e.g., 2D cases and 3D cases). Additionally, aspects presented herein may provide an improved image quality (e.g., an improved edge quality) for a number of different MSAA-related solutions (e.g., non-MSAA and 4xMSAA).

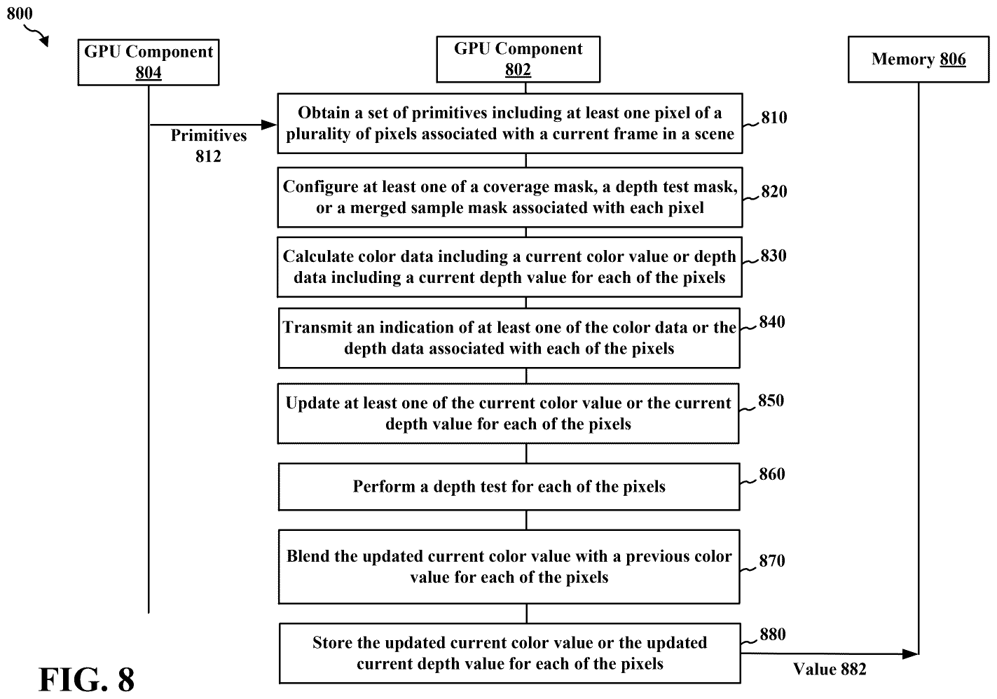

FIG. 8 is a communication flow diagram 800 of graphics processing in accordance with one or more techniques of this disclosure. As shown in FIG. 8, diagram 800 includes example communications between GPU component 802 (e.g., a component in a GPU or GPU pipeline, software for controlling a GPU, or a processor for controlling a GPU), GPU component 804 (e.g., a component in a GPU or GPU pipeline, or other graphics processor), and memory 806 (e.g., a graphics memory or GMEM, or system memory), in accordance with one or more techniques of this disclosure.

At 810, GPU component 802 may obtain a set of primitives (e.g., receive primitives 812 from GPU component 804) associated with at least one current frame in a scene, where each of the set of primitives is associated with at least one pixel of a plurality of pixels in the at least one current frame.

At 820, GPU component 802 may configure at least one coverage mask associated with each pixel of the plurality of pixels, where each of the plurality of pixels corresponds to at least one sample, where the at least one coverage mask is based on the at least one sample for each of the plurality of pixels. Additionally, at 820, GPU component 802 may configure at least one depth test mask associated with the depth data for each of the plurality of pixels, where the at least one depth test mask is based on the at least one sample for each of the plurality of pixels. At least one of the current color value or the current depth value for each of the plurality of pixels may be further updated based on the at least one depth test mask. Further, at 820, GPU component 802 may configure at least one merged sample mask based on a combination of the at least one coverage mask and the at least one depth test mask. At least one of the current color value or the current depth value for each of the plurality of pixels may be further updated based on the at least one merged sample mask. The at least one coverage mask may be at least one sample coverage mask. Also, the at least one coverage mask may be configured based on a multi-sample anti-aliasing (MSAA) process.

At 830, GPU component 802 may calculate at least one of color data or depth data associated with each of the plurality of pixels, where the color data includes a current color value for each of the plurality of pixels, where the depth data includes a current depth value for each of the plurality of pixels. The color data may include a set of color values associated with each of the plurality of pixels, and the depth data may include a set of depth values associated with each of the plurality of pixels.

At 840, GPU component 802 may transmit an indication of at least one of the color data or the depth data associated with each of the plurality of pixels, where the indication is transmitted after calculating at least one of the color data or the depth data associated with each of the plurality of pixels.

At 850, GPU component 802 may update at least one of the current color value or the current depth value for each of the plurality of pixels based on the at least one coverage mask, or at least one merged sample mask. Also, at least one of the current color value or the current depth value may be calculated by a shader processor in a graphics processing unit (GPU) at 830.

At 860, GPU component 802 may perform a depth test for each of the plurality of pixels prior to the updated current color value being blended with the previous color value for each of the plurality of pixels. In some aspects, performing the depth test for each of the plurality of pixels may include: comparing the current depth value for each of the plurality of pixels and the previous depth value for each of the plurality of pixels. That is, the GPU may compare the current depth value for each of the plurality of pixels and the previous depth value for each of the plurality of pixels. The depth test may be performed by a render backend (RB) in a graphics processing unit (GPU).

At 870, GPU component 802 may blend the updated current color value for each of the plurality of pixels with a previous color value for each of the plurality of pixels, where the updated current color value is associated with at least one current draw for the scene, and where the previous color value is associated with at least one previous draw for the scene.

At 880, GPU component 802 may store at least one of the updated current color value or the updated current depth value for each of the plurality of pixels (e.g., store value 882 in memory 806) after the updated current color value is blended with the previous color value for each of the plurality of pixels. At least one of the updated current color value or the updated current depth value for each of the plurality of pixels may be stored in a graphics processing unit (GPU) memory (GMEM) or a system memory. Additionally, at 880, GPU component 802 may generate at least one of the updated current color value or the updated current depth value for each of the plurality of pixels prior to storing at least one of the updated current color value or the updated current depth value.

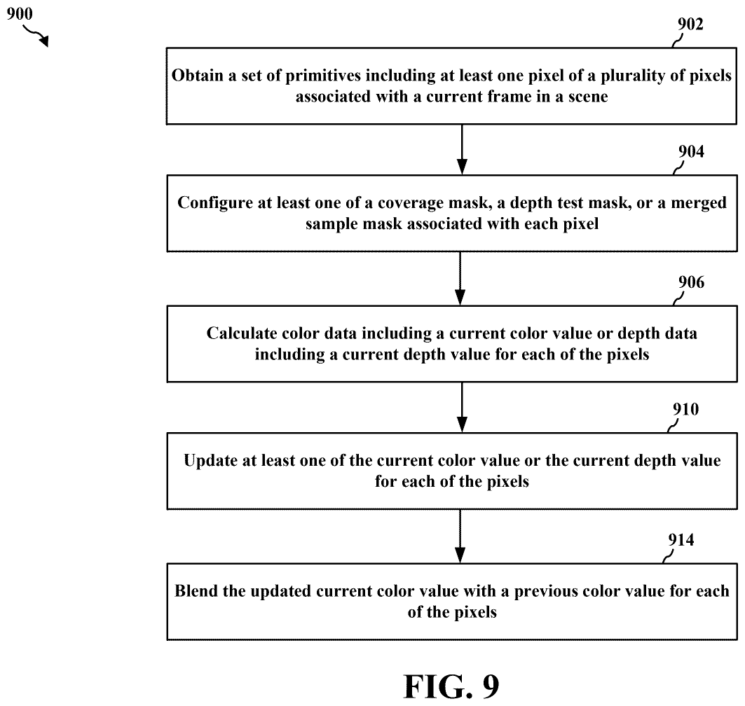

FIG. 9 is a flowchart 900 of an example method of graphics processing in accordance with one or more techniques of this disclosure. The method may be performed by a GPU, a GPU component (e.g., a component in a GPU or GPU pipeline, software for controlling a GPU, or a processor for controlling a GPU), a graphics processor, a CPU (or other central processor), an apparatus for graphics processing, a wireless communication device, and/or any apparatus that may perform graphics processing as used in connection with the examples of FIGS. 1-8.

At 902, the GPU may obtain a set of primitives associated with at least one current frame in a scene, where each of the set of primitives is associated with at least one pixel of a plurality of pixels in the at least one current frame, as described in connection with the examples in FIGS. 1-8. For example, as described in 810 of FIG. 8, GPU component 802 may obtain a set of primitives associated with at least one current frame in a scene, where each of the set of primitives is associated with at least one pixel of a plurality of pixels in the at least one current frame. Further, step 902 may be performed by processing unit 120 in FIG. 1.

At 904, the GPU may configure at least one coverage mask associated with each pixel of the plurality of pixels, where each of the plurality of pixels corresponds to at least one sample, where the at least one coverage mask is based on the at least one sample for each of the plurality of pixels, as described in connection with the examples in FIGS. 1-8. For example, as described in 820 of FIG. 8, GPU component 802 may configure at least one coverage mask associated with each pixel of the plurality of pixels, where each of the plurality of pixels corresponds to at least one sample, where the at least one coverage mask is based on the at least one sample for each of the plurality of pixels. Further, step 904 may be performed by processing unit 120 in FIG. 1. Additionally, at 904, the GPU may configure at least one depth test mask associated with the depth data for each of the plurality of pixels, where the at least one depth test mask is based on the at least one sample for each of the plurality of pixels. At least one of the current color value or the current depth value for each of the plurality of pixels may be further updated based on the at least one depth test mask. Further, at 904, the GPU may configure at least one merged sample mask based on a combination of the at least one coverage mask and the at least one depth test mask. At least one of the current color value or the current depth value for each of the plurality of pixels may be further updated based on the at least one merged sample mask. The at least one coverage mask may be at least one sample coverage mask. Also, the at least one coverage mask may be configured based on a multi-sample anti-aliasing (MSAA) process.

At 906, the GPU may calculate at least one of color data or depth data associated with each of the plurality of pixels, where the color data includes a current color value for each of the plurality of pixels, where the depth data includes a current depth value for each of the plurality of pixels, as described in connection with the examples in FIGS. 1-8. For example, as described in 830 of FIG. 8, GPU component 802 may calculate at least one of color data or depth data associated with each of the plurality of pixels, where the color data includes a current color value for each of the plurality of pixels, where the depth data includes a current depth value for each of the plurality of pixels. Further, step 906 may be performed by processing unit 120 in FIG. 1. The color data may include a set of color values associated with each of the plurality of pixels, and the depth data may include a set of depth values associated with each of the plurality of pixels.

At 910, the GPU may update at least one of the current color value or the current depth value for each of the plurality of pixels based on the at least one coverage mask or at least one merged sample mask, as described in connection with the examples in FIGS. 1-8. For example, as described in 850 of FIG. 8, GPU component 802 may update at least one of the current color value or the current depth value for each of the plurality of pixels based on the at least one coverage mask or at least one merged sample mask. Further, step 910 may be performed by processing unit 120 in FIG. 1. Also, at least one of the current color value or the current depth value may be calculated by a shader processor in a GPU at 906.

At 914, the GPU may blend the updated current color value for each of the plurality of pixels with a previous color value for each of the plurality of pixels, where the updated current color value is associated with at least one current draw for the scene, and where the previous color value is associated with at least one previous draw for the scene, as described in connection with the examples in FIGS. 1-8. For example, as described in 870 of FIG. 8, GPU component 802 may blend the updated current color value for each of the plurality of pixels with a previous color value for each of the plurality of pixels, where the updated current color value is associated with at least one current draw for the scene, and where the previous color value is associated with at least one previous draw for the scene. Further, step 914 may be performed by processing unit 120 in FIG. 1.

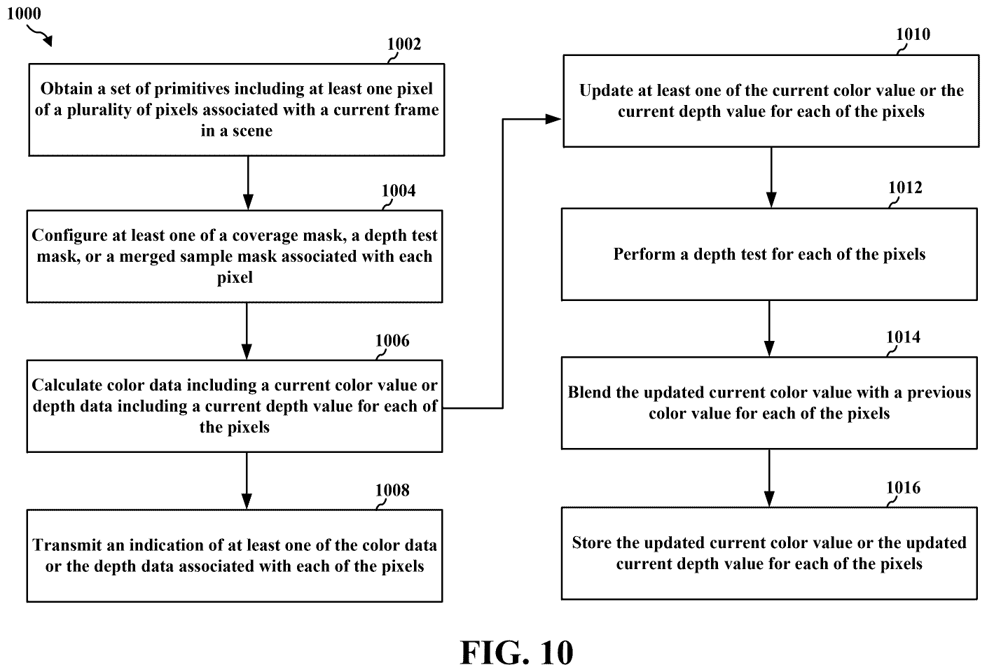

FIG. 10 is a flowchart 1000 of an example method of graphics processing in accordance with one or more techniques of this disclosure. The method may be performed by a GPU, a GPU component (e.g., a component in a GPU or GPU pipeline, software for controlling a GPU, or a processor for controlling a GPU), a graphics processor, a CPU (or other central processor), an apparatus for graphics processing, a wireless communication device, and/or any apparatus that may perform graphics processing as used in connection with the examples of FIGS. 1-8.

At 1002, the GPU may obtain a set of primitives associated with at least one current frame in a scene, where each of the set of primitives is associated with at least one pixel of a plurality of pixels in the at least one current frame, as described in connection with the examples in FIGS. 1-8. For example, as described in 810 of FIG. 8, GPU component 802 may obtain a set of primitives associated with at least one current frame in a scene, where each of the set of primitives is associated with at least one pixel of a plurality of pixels in the at least one current frame. Further, step 1002 may be performed by processing unit 120 in FIG. 1.

At 1004, the GPU may configure at least one coverage mask associated with each pixel of the plurality of pixels, where each of the plurality of pixels corresponds to at least one sample, where the at least one coverage mask is based on the at least one sample for each of the plurality of pixels, as described in connection with the examples in FIGS. 1-8. For example, as described in 820 of FIG. 8, GPU component 802 may configure at least one coverage mask associated with each pixel of the plurality of pixels, where each of the plurality of pixels corresponds to at least one sample, where the at least one coverage mask is based on the at least one sample for each of the plurality of pixels. Further, step 1004 may be performed by processing unit 120 in FIG. 1. Additionally, at 1004, the GPU may configure at least one depth test mask associated with the depth data for each of the plurality of pixels, where the at least one depth test mask is based on the at least one sample for each of the plurality of pixels. At least one of the current color value or the current depth value for each of the plurality of pixels may be further updated based on the at least one depth test mask. Further, at 1004, the GPU may configure at least one merged sample mask based on a combination of the at least one coverage mask and the at least one depth test mask. At least one of the current color value or the current depth value for each of the plurality of pixels may be further updated based on the at least one merged sample mask. The at least one coverage mask may be at least one sample coverage mask. Also, the at least one coverage mask may be configured based on a multi-sample anti-aliasing (MSAA) process.

At 1006, the GPU may calculate at least one of color data or depth data associated with each of the plurality of pixels, where the color data includes a current color value for each of the plurality of pixels, where the depth data includes a current depth value for each of the plurality of pixels, as described in connection with the examples in FIGS. 1-8. For example, as described in 830 of FIG. 8, GPU component 802 may calculate at least one of color data or depth data associated with each of the plurality of pixels, where the color data includes a current color value for each of the plurality of pixels, where the depth data includes a current depth value for each of the plurality of pixels. Further, step 1006 may be performed by processing unit 120 in FIG. 1. The color data may include a set of color values associated with each of the plurality of pixels, and the depth data may include a set of depth values associated with each of the plurality of pixels.

At 1008, the GPU may transmit an indication of at least one of the color data or the depth data associated with each of the plurality of pixels, where the indication is transmitted after calculating at least one of the color data or the depth data associated with each of the plurality of pixels, as described in connection with the examples in FIGS. 1-8. For example, as described in 840 of FIG. 8, GPU component 802 may transmit an indication of at least one of the color data or the depth data associated with each of the plurality of pixels, where the indication is transmitted after calculating at least one of the color data or the depth data associated with each of the plurality of pixels. Further, step 1008 may be performed by processing unit 120 in FIG. 1.

At 1010, the GPU may update at least one of the current color value or the current depth value for each of the plurality of pixels based on the at least one coverage mask, as described in connection with the examples in FIGS. 1-8. For example, as described in 850 of FIG. 8, GPU component 802 may update at least one of the current color value or the current depth value for each of the plurality of pixels based on the at least one coverage mask. Further, step 1010 may be performed by processing unit 120 in FIG. 1. Also, at least one of the current color value or the current depth value may be calculated by a shader processor in a GPU.

At 1012, the GPU may perform a depth test for each of the plurality of pixels prior to the updated current color value being blended with the previous color value for each of the plurality of pixels, as described in connection with the examples in FIGS. 1-8. For example, as described in 860 of FIG. 8, GPU component 802 may perform a depth test for each of the plurality of pixels prior to the updated current color value being blended with the previous color value for each of the plurality of pixels. Further, step 1012 may be performed by processing unit 120 in FIG. 1. In some aspects, performing the depth test for each of the plurality of pixels may include: comparing the current depth value for each of the plurality of pixels and the previous depth value for each of the plurality of pixels. That is, the GPU may compare the current depth value for each of the plurality of pixels and the previous depth value for each of the plurality of pixels. The depth test may be performed by a render backend (RB) in a graphics processing unit (GPU).

At 1014, the GPU may blend the updated current color value for each of the plurality of pixels with a previous color value for each of the plurality of pixels, where the updated current color value is associated with at least one current draw for the scene, and where the previous color value is associated with at least one previous draw for the scene, as described in connection with the examples in FIGS. 1-8. For example, as described in 870 of FIG. 8, GPU component 802 may blend the updated current color value for each of the plurality of pixels with a previous color value for each of the plurality of pixels, where the updated current color value is associated with at least one current draw for the scene, and where the previous color value is associated with at least one previous draw for the scene. Further, step 1014 may be performed by processing unit 120 in FIG. 1.

At 1016, the GPU may store at least one of the updated current color value or the updated current depth value for each of the plurality of pixels after the updated current color value is blended with the previous color value for each of the plurality of pixels, as described in connection with the examples in FIGS. 1-8. For example, as described in 880 of FIG. 8, GPU component 802 may store at least one of the updated current color value or the updated current depth value for each of the plurality of pixels after the updated current color value is blended with the previous color value for each of the plurality of pixels. Further, step 1016 may be performed by processing unit 120 in FIG. 1. At least one of the updated current color value or the updated current depth value for each of the plurality of pixels may be stored in a graphics processing unit (GPU) memory (GMEM) or a system memory. Additionally, 1016, the GPU may generate at least one of the updated current color value or the updated current depth value for each of the plurality of pixels prior to storing at least one of the updated current color value or the updated current depth value.

In configurations, a method or an apparatus for graphics processing is provided. The apparatus may be a GPU, a GPU component (e.g., a component in a GPU or GPU pipeline, software for controlling a GPU, or a processor for controlling a GPU), a graphics processor, a CPU (or other central processor), an apparatus for graphics processing, a wireless communication device, and/or some other processor that may perform graphics processing. In aspects, the apparatus may be the processing unit 120 within the device 104, or may be some other hardware within the device 104 or another device. The apparatus, e.g., processing unit 120, may include means for obtaining a set of primitives associated with at least one current frame in a scene, where each of the set of primitives is associated with at least one pixel of a plurality of pixels in the at least one current frame. The apparatus, e.g., processing unit 120, may also include means for configuring at least one coverage mask associated with each pixel of the plurality of pixels, where each of the plurality of pixels corresponds to at least one sample, where the at least one coverage mask is based on the at least one sample for each of the plurality of pixels. The apparatus, e.g., processing unit 120, may also include means for calculating at least one of color data or depth data associated with each of the plurality of pixels, where the color data includes a current color value for each of the plurality of pixels, where the depth data includes a current depth value for each of the plurality of pixels. The apparatus, e.g., processing unit 120, may also include means for updating at least one of the current color value or the current depth value for each of the plurality of pixels based on the at least one coverage mask. The apparatus, e.g., processing unit 120, may also include means for blending the updated current color value for each of the plurality of pixels with a previous color value for each of the plurality of pixels based on the at least one coverage mask, where the updated current color value is associated with at least one current draw for the scene, and where the previous color value is associated with at least one previous draw for the scene. The apparatus, e.g., processing unit 120, may also include means for performing a depth test for each of the plurality of pixels prior to the updated current color value being blended with the previous color value for each of the plurality of pixels. The apparatus, e.g., processing unit 120, may also include means for configuring at least one depth test mask associated with the depth data for each of the plurality of pixels, where the at least one depth test mask is based on the at least one sample for each of the plurality of pixels. The apparatus, e.g., processing unit 120, may also include means for configuring at least one merged sample mask based on a combination of the at least one coverage mask and the at least one depth test mask. The apparatus, e.g., processing unit 120, may also include means for transmitting an indication of at least one of the color data or the depth data associated with each of the plurality of pixels, where the indication is transmitted after calculating at least one of the color data or the depth data associated with each of the plurality of pixels. The apparatus, e.g., processing unit 120, may also include means for storing at least one of the updated current color value or the updated current depth value for each of the plurality of pixels after the updated current color value is blended with the previous color value for each of the plurality of pixels. The apparatus, e.g., processing unit 120, may also include means for generating at least one of the updated current color value or the updated current depth value for each of the plurality of pixels prior to storing at least one of the updated current color value or the updated current depth value.

The subject matter described herein may be implemented to realize one or more benefits or advantages. For instance, the described graphics processing techniques may be used by a GPU, a GPU component, a CPU, a graphics processor, an apparatus for graphics processing, or some other processor that may perform graphics processing to implement the MSAA techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize MSAA techniques in order to improve memory bandwidth efficiency and/or increase processing speed at a GPU or CPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including a memory and at least one processor coupled to the memory and, based at least in part on information stored in the memory, the at least one processor is configured to: obtain a set of primitives associated with at least one current frame in a scene, where each of the set of primitives is associated with at least one pixel of a plurality of pixels in the at least one current frame; configure at least one coverage mask associated with each pixel of the plurality of pixels, where each of the plurality of pixels corresponds to at least one sample, where the at least one coverage mask is based on the at least one sample for each of the plurality of pixels; calculate at least one of color data or depth data associated with each of the plurality of pixels, where the color data includes a current color value for each of the plurality of pixels, where the depth data includes a current depth value for each of the plurality of pixels; update at least one of the current color value or the current depth value for each of the plurality of pixels based on the at least one coverage mask; and blend the updated current color value for each of the plurality of pixels with a previous color value for each of the plurality of pixels, where the updated current color value is associated with at least one current draw for the scene, and where the previous color value is associated with at least one previous draw for the scene.

Aspect 2 is the apparatus of aspect 1, where the at least one processor is further configured to: perform a depth test for each of the plurality of pixels prior to the updated current color value being blended with the previous color value for each of the plurality of pixels.

Aspect 3 is the apparatus of any of aspects 1 and 2, where to perform the depth test for each of the plurality of pixels, the at least one processor is configured to: compare the current depth value for each of the plurality of pixels and the previous depth value for each of the plurality of pixels.

Aspect 4 is the apparatus of any of aspects 1 to 3, where the depth test is performed by a render backend (RB) in a graphics processing unit (GPU).

Aspect 5 is the apparatus of any of aspects 1 to 4, where the at least one processor is further configured to: configure at least one depth test mask associated with the depth data for each of the plurality of pixels, where the at least one depth test mask is based on the at least one sample for each of the plurality of pixels.

Aspect 6 is the apparatus of any of aspects 1 to 5, where at least one of the current color value or the current depth value for each of the plurality of pixels is further updated based on the at least one depth test mask.

Aspect 7 is the apparatus of any of aspects 1 to 6, where the at least one processor is further configured to: configure at least one merged sample mask based on a combination of the at least one coverage mask and the at least one depth test mask.

Aspect 8 is the apparatus of any of aspects 1 to 7, where at least one of the current color value or the current depth value for each of the plurality of pixels is further updated based on the at least one merged sample mask.

Aspect 9 is the apparatus of any of aspects 1 to 8, where the color data includes a set of color values associated with each of the plurality of pixels, and where the depth data includes a set of depth values associated with each of the plurality of pixels.

Aspect 10 is the apparatus of any of aspects 1 to 9, where transmit an indication of at least one of the color data or the depth data associated with each of the plurality of pixels, where the indication is transmitted after calculating at least one of the color data or the depth data associated with each of the plurality of pixels.

Aspect 11 is the apparatus of any of aspects 1 to 10, where the at least one processor is further configured to: store at least one of the updated current color value or the updated current depth value for each of the plurality of pixels after the updated current color value is blended with the previous color value for each of the plurality of pixels.

Aspect 12 is the apparatus of any of aspects 1 to 11, where at least one of the updated current color value or the updated current depth value for each of the plurality of pixels is stored in a graphics processing unit (GPU) memory (GMEM) or a system memory.

Aspect 13 is the apparatus of any of aspects 1 to 12, where the at least one processor is further configured to: generate at least one of the updated current color value or the updated current depth value for each of the plurality of pixels prior to storing at least one of the updated current color value or the updated current depth value.

Aspect 14 is the apparatus of any of aspects 1 to 13, where the at least one coverage mask is at least one sample coverage mask.

Aspect 15 is the apparatus of any of aspects 1 to 14, where the at least one coverage mask is configured based on a multi-sample anti-aliasing (MSAA) process.

Aspect 16 is the apparatus of any of aspects 1 to 15, where at least one of the current color value or the current depth value is calculated by a shader processor in a graphics processing unit (GPU).

Aspect 17 is the apparatus of any of aspects 1 to 16, where the apparatus is a wireless communication device, further including at least one of an antenna or a transceiver coupled to the at least one processor.

Aspect 18 is a method of graphics processing for implementing any of aspects 1 to 16.

Aspect 19 is an apparatus for graphics processing including means for implementing any of aspects 1 to 16.

Aspect 20 is a computer-readable medium (e.g., a non-transitory computer-readable medium) storing computer executable code, the code when executed by at least one processor causes the at least one processor to implement any of aspects 1 to 16.

1. An apparatus for graphics processing, comprising:
a memory; and
at least one processor coupled to the memory and, based at least in part on information stored in the memory, the at least one processor is configured to:
obtain a set of primitives associated with at least one current frame in a scene, wherein each of the set of primitives is associated with at least one pixel of a plurality of pixels in the at least one current frame;
configure at least one coverage mask associated with each pixel of the plurality of pixels, wherein each of the plurality of pixels corresponds to at least one sample, wherein the at least one coverage mask is based on the at least one sample for each of the plurality of pixels;
calculate at least one of color data or depth data associated with each of the plurality of pixels, wherein the color data includes a current color value for each of the plurality of pixels, wherein the depth data includes a current depth value for each of the plurality of pixels;
update at least one of the current color value or the current depth value for each of the plurality of pixels based on the at least one coverage mask; and
blend the updated current color value for each of the plurality of pixels with a previous color value for each of the plurality of pixels, wherein the updated current color value is associated with at least one current draw for the scene, and wherein the previous color value is associated with at least one previous draw for the scene.

2. The apparatus of claim 1, wherein the at least one processor is further configured to:
perform a depth test for each of the plurality of pixels prior to the updated current color value being blended with the previous color value for each of the plurality of pixels.

3. The apparatus of claim 2, wherein to perform the depth test for each of the plurality of pixels, the at least one processor is configured to: compare the current depth value for each of the plurality of pixels and the previous depth value for each of the plurality of pixels.

4. The apparatus of claim 2, wherein the depth test is performed by a render backend (RB) in a graphics processing unit (GPU).

5. The apparatus of claim 1, wherein the at least one processor is further configured to:
configure at least one depth test mask associated with the depth data for each of the plurality of pixels, wherein the at least one depth test mask is based on the at least one sample for each of the plurality of pixels.

6. The apparatus of claim 5, wherein at least one of the current color value or the current depth value for each of the plurality of pixels is further updated based on the at least one depth test mask.

7. The apparatus of claim 5, wherein the at least one processor is further configured to:
configure at least one merged sample mask based on a combination of the at least one coverage mask and the at least one depth test mask.

8. The apparatus of claim 7, wherein at least one of the current color value or the current depth value for each of the plurality of pixels is further updated based on the at least one merged sample mask.

9. The apparatus of claim 1, wherein the color data includes a set of color values associated with each of the plurality of pixels, and wherein the depth data includes a set of depth values associated with each of the plurality of pixels.

10. The apparatus of claim 1, wherein the at least one processor is further configured to:
transmit an indication of at least one of the color data or the depth data associated with each of the plurality of pixels, wherein the indication is transmitted after calculating at least one of the color data or the depth data associated with each of the plurality of pixels.

11. The apparatus of claim 1, wherein the at least one processor is further configured to:
store at least one of the updated current color value or the updated current depth value for each of the plurality of pixels after the updated current color value is blended with the previous color value for each of the plurality of pixels.

12. The apparatus of claim 11, wherein at least one of the updated current color value or the updated current depth value for each of the plurality of pixels is stored in a graphics processing unit (GPU) memory (GMEM) or a system memory.

13. The apparatus of claim 11, wherein the at least one processor is further configured to:
generate at least one of the updated current color value or the updated current depth value for each of the plurality of pixels prior to storing at least one of the updated current color value or the updated current depth value.

14. The apparatus of claim 1, wherein the at least one coverage mask is at least one sample coverage mask.

15. The apparatus of claim 1, wherein the at least one coverage mask is configured based on a multi-sample anti-aliasing (MSAA) process.

16. The apparatus of claim 1, further comprising at least one of an antenna or a transceiver coupled to the at least one processor, wherein at least one of the current color value or the current depth value is calculated by a shader processor in a graphics processing unit (GPU).

17. A method of graphics processing, comprising:
obtaining a set of primitives associated with at least one current frame in a scene, wherein each of the set of primitives is associated with at least one pixel of a plurality of pixels in the at least one current frame;
configuring at least one coverage mask associated with each pixel of the plurality of pixels, wherein each of the plurality of pixels corresponds to at least one sample, wherein the at least one coverage mask is based on the at least one sample for each of the plurality of pixels;
calculating at least one of color data or depth data associated with each of the plurality of pixels, wherein the color data includes a current color value for each of the plurality of pixels, wherein the depth data includes a current depth value for each of the plurality of pixels;
updating at least one of the current color value or the current depth value for each of the plurality of pixels based on the at least one coverage mask; and
blending the updated current color value for each of the plurality of pixels with a previous color value for each of the plurality of pixels, wherein the updated current color value is associated with at least one current draw for the scene, and wherein the previous color value is associated with at least one previous draw for the scene.

18. The method of claim 17, further comprising:
performing a depth test for each of the plurality of pixels prior to the updated current color value being blended with the previous color value for each of the plurality of pixels.

19. The method of claim 18, wherein performing the depth test for each of the plurality of pixels comprises: comparing the current depth value for each of the plurality of pixels and the previous depth value for each of the plurality of pixels.

20. The method of claim 18, wherein the depth test is performed by a render backend (RB) in a graphics processing unit (GPU).

21-30. (canceled)
